(19) United States
(12) Patent Application Publication
(10) Pub. No.: US 2020/0013055 A1
(43) Pub. Date: Jan. 9, 2020

(54) Systems and Methods for Blockchain Based Identity Verification and Transaction Processing

(71) Applicant: ENVIRONMENTAL FINANCIAL PRODUCTS, LLC, Chicago, IL (US)

(72) Inventor: Richard L. Sandor, Chicago, IL (US)

(21) Appl. No.: 16/506,565

(22) Filed: Jul. 9, 2019

Related U.S. Application Data
(60) Provisional application No. 62/695,521, filed on Jul. 9, 2018.

(51) Int. Cl. G06Q 20/38; H04L 9/06; G06Q 20/06; G06Q 20/36; G06Q 20/40

(52) U.S. Cl. CPC G06Q 20/38215; H04L 9/0637; G06Q 20/4014; G06Q 20/3674; G06Q 20/0658

(57) ABSTRACT

A system and method are provided which allow blockchain-based identity verification and transaction processing. The system allows individual account holders to conduct cryptocurrency-based transactions while providing identity verification in compliance with know your customer rules as well as potential identity verification to third parties conducting transactions with the account holder. The system includes user-selectable preferences to allow their financial institution to automatically generate a digitally signed depository receipt (DSDR) which is the financial institution's statement as to the amount of bitcoin that is currently credited to the account of the original depositor as of the timestamp of the digitally signed depository receipt. The DSDR may also serve as identity verification of the account holder by linking a public key provided by an account holder with a registered identity established at and vouched for by a financial institution.

### CROSS-REFERENCE TO RELATED APPLICATIONS

The present application claims the benefit of U.S. Provisional Application No. 62/695,521, filed Jul. 9, 2018, entitled “SYSTEMS AND METHODS FOR BLOCKCHAIN BASED IDENTITY VERIFICATION AND TRANSACTION PROCESSING”, which is hereby incorporated by reference in its entirety.

### BACKGROUND OF THE INVENTION

The present invention generally relates to a computerized blockchain-based transaction system. More particularly, the present invention relates to a computerized blockchain-based transaction system including identity verification.

Cryptocurrency systems based on blockchain processing, such as Bitcoin and Ethereum often emphasize anonymity as one of their desirably traits. However, blockchain-based cryptocurrencies also may provide other benefits, such as speed of transaction processing and ease of currency conversion, that do not rely on anonymity. Further, anonymity may be desired by end users with regard to other potential transaction partners, but may not necessarily be required with regard to a transaction intermediary, such as a financial institution. Additionally, financial institutions may have country-specific identity requirements, such as the U.S. Know-Your-Customer (KYC) requirements, that may require at least some identifiable information for an account holder.

### BRIEF SUMMARY OF THE INVENTION

One or more of the embodiments of the present invention provide a blockchain-based identity verification and transaction processing system. The system may be usable with cryptocurrency such as Bitcoin or Ethereum. The system allows individual account holders to conduct cryptocurrency-based transactions while providing identity verification in compliance with know your customer rules as well as potential identity verification to third parties conducting transactions with the account holder, a feature expressly not available through a standard blockchain-based cryptocurrency transaction.

In one embodiment, the account holder may set their preferences to allow their financial institution to automatically generate a digitally signed depository receipt (DSDR) which is the financial institution's statement as to the amount of bitcoin that is currently credited to the account of the original depositor as of the timestamp of the digitally signed depository receipt. The DSDR may also serve as identity verification of the account holder by linking a public key provided by an account holder with a registered identity established at and vouched for by a financial institution.

### BRIEF DESCRIPTION OF THE DRAWINGS

FIG. 1 illustrates a system for blockchain-based identity verification and transaction processing according to an embodiment of the present invention.

FIG. 2a illustrates a flowchart of a method for deposit account identity confirmation.

FIG. 2b illustrates a flowchart of a method for deposit account creation, according to an embodiment of the present invention.

FIG. 3 illustrates a flowchart of a method for funding a deposit account with cryptocurrency received from a predetermined public key or digital wallet.

FIG. 4 illustrates a flowchart of a method for processing an outgoing transaction from the deposit account system.

FIG. 5 illustrates a flowchart of a method for automated identity verification according to an embodiment of the present invention.

FIG. 6 illustrates a flowchart of a method for implementing the auto-allow preference.

FIG. 7 illustrates a flowchart of a method for implementing the conditional permission preference.

FIG. 8 illustrates a flowchart of a method for implementing the not allowed preference.

FIG. 9 illustrates a flowchart of a method for deposit account cold storage.

FIG. 10 illustrates a flowchart of a method for cold storage at the institution or bank level rather than the deposit account level.

FIG. 11 illustrates a deposit account key pair that was created at the time the deposit account was created, as was an account-level cold storage key pairs that is associated with the deposit account key pair.

FIG. 12 illustrates the deposit account key pairs transaction with the main bank transaction accounts key pair.

### DETAILED DESCRIPTION OF THE INVENTION

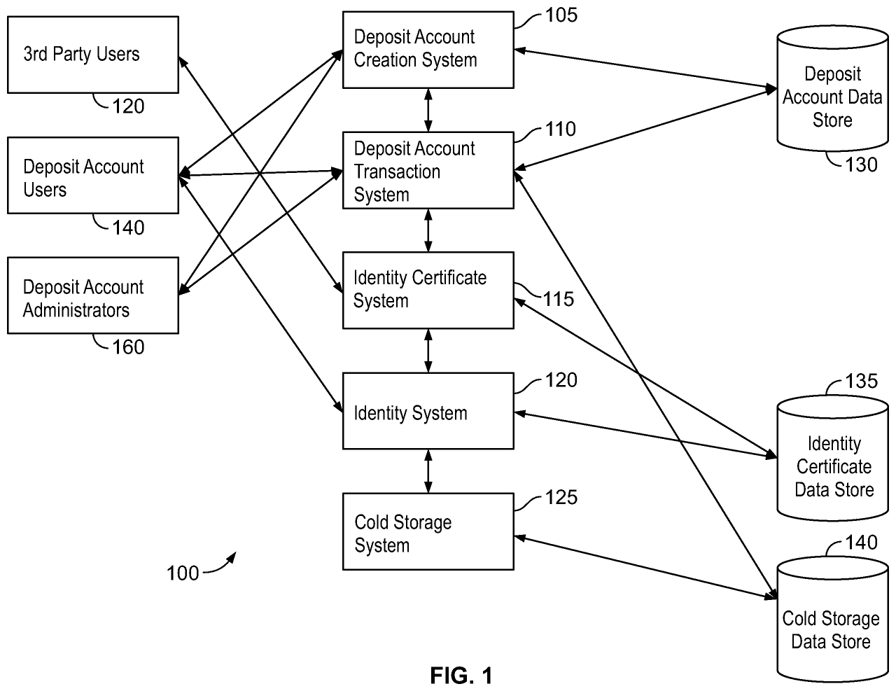

FIG. 1 illustrates a system for blockchain-based identity verification and transaction processing 100 according to an embodiment of the present invention. The system 100 includes a deposit account creation system 105, a deposit account transaction system 110, an identity certificate system 115, an identity system 120, a cold storage system 125, a deposit account data store 130, an identity certificate data store 135, a cold storage data store 140, deposit account users 150, deposit account administrators 160, and third party users 170. The operation of the system 100 is further described with reference to the Figures below.

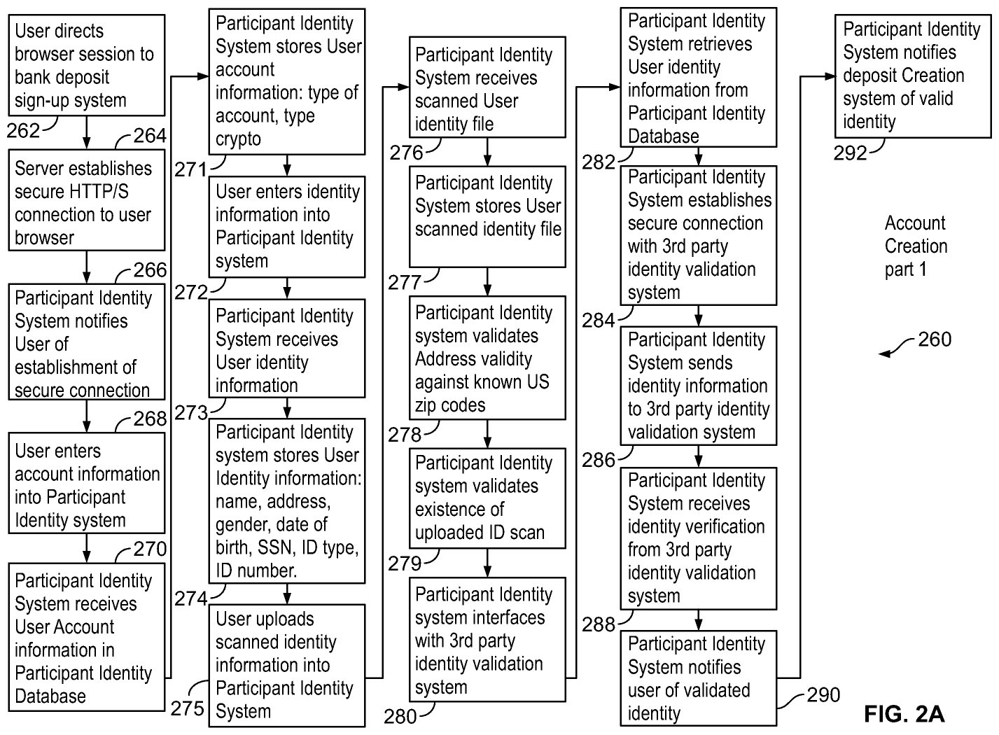

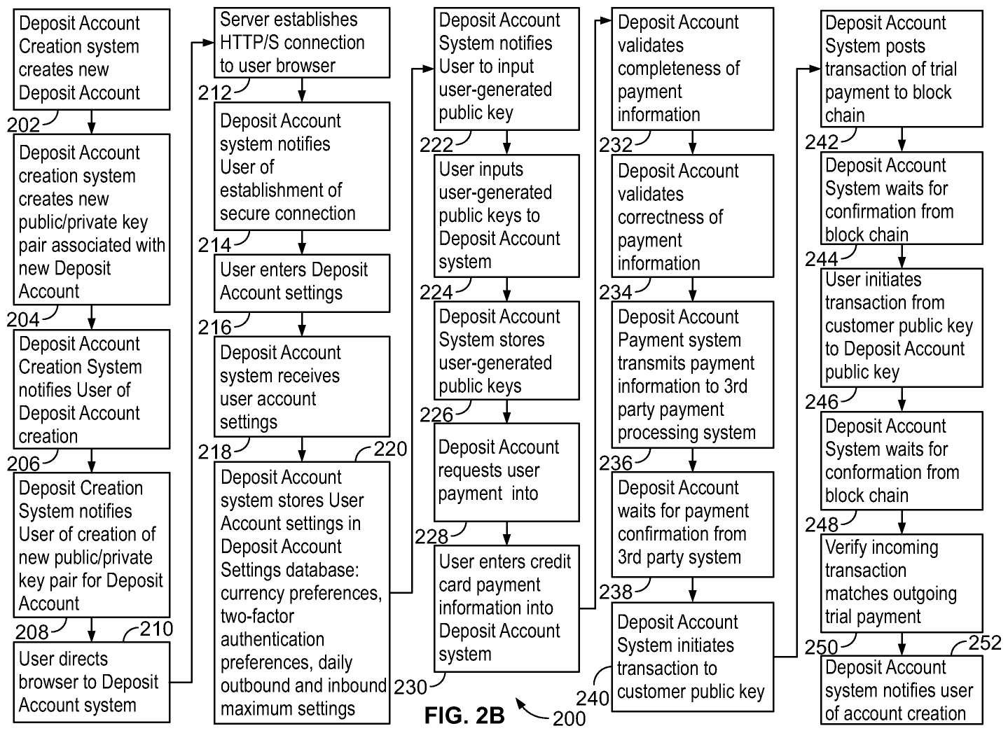

FIG. 2a illustrates a flowchart 260 of a method for deposit account identity confirmation. First, at step 262, the user directs a browser session to the bank deposit sign-up system for the participant identity creation aspect of the deposit account creation system. Next, at step 264, the server upon which the deposit account system is operating establishes a secure connection with the user's browser, such as a HTTP/S connection. Next, at step 266, the participant identity system notifies the user's browser of the establishment of a secure connection and an indication may be displayed for the user. Then, at step 268, the user enters account information into the browser session that is passed through the secure connection to the participant identity system. At step 270, the participant identity system received the user account information and stores it in the participant identity database or the deposit account data store. At step 271, the participant identity system stores the user account information including the type of user account and the type of cryptographic currency associated with the user account. At step 272, the user enters identity information into the browser session which is then passed to the participant identity system at step 273. At step 274, the participant identity system stores the user identity information including the name, address, gender, date of birth, social security number, ID type, and ID number of the user. At step 275, the user uploads scanned identity information into the participant identity system. Next, at step 276, the participant identity system receives the scanned user identity file and at step 277 stores the user scanned identity file. At step 278, the participant identity system validates the address validity against known US zip codes. At step 279, the participant identity system validates the existence of the uploaded ID scan, a portion of that process takes place at step 280 where the participant identity system interfaces with a 3^{rd} party identity validation system.

At step 282, the participant identity system retrieves user identity information from the participant identity database or the deposit account data store. Next, at step 284, the participant identity system establishes a secure connection with a 3^{rd} party identity validation system. At step 286, the participant identity system sends identity information to the 3^{rd} party identity validation system and at step 288 the participant identity system received identity verification from the 3^{rd} party identity validation system. Next, at step 290, the participant identity system notifies the user of a validated identity through the secure browser connection. At step 292, the participant identity system notifies the deposit account creation system of a valid identity. The process may then proceed to the flowchart shown in FIG. 2b.

FIG. 2b illustrates a flowchart 200 of a method for deposit account creation, according to an embodiment of the present invention. First, at step 202, the deposit account creation system creates a new deposit account electronic entry and stores it in memory. At step 204, the deposit account creation system automatically creates a new public/private key pair and associates the public/private key pair with the new deposit account. In one example, the deposit account comprises a data structure having several data elements as identified herein, including an account identifier and the public/private key pair. In another example, the deposit account only includes the account identifier and the public key and the private key is stored in a higher security memory location.

At step 206, the deposit account creation system electronically notifies the user that the deposit account has been created. In one embodiment, the deposit account creation is performed using a browser in communication with the deposit account creation system and the deposit account creation system may transmit an electronic communication to the browser for display to the user. At step 208, the deposit account creation system notifies the user of the creation of the public/private key pair for the user's deposit account. Next, at step 210, the user directs the browser to the deposit account system. For example, when the present method is being implemented using a browser, the user may click on an electronic link in the browser interface in order to instruct the browser to initiate communication with the deposit account system.

Then, at step 212, the server upon which the deposit account system is operating establishes a secure connection with the user's browser, such as a HTTP/S connection. Next, at step 214, the deposit account system notifies the user's browser of the establishment of a secure connection and an indication may be displayed for the user. Then, at step 216, the browser displays an interface to allow the user to configure the settings for the deposit account. The settings for the deposit account are transmitted from the browser interface using the secure connection to the deposit account system in step 218. The settings may include user currency preference, two-factor authentication preference, daily outbound and inbound transfer maximum value settings, for example. At step 220, the deposit account system stores the user account settings in the deposit account settings database.

Additionally, verifiable user information is also preferably transmitted to the deposit account system. In one embodiment, the deposit account system requires the submission of verifiable user information similar to that required when opening a credit card and/or bank account include social security number, driver's license number or image, security questions, for example. The present system thus provides bank-level identity verification as part of the account setup so that the system and be certain as to the identity of the user establishing the account.

Next, at step 222, the deposit account system notifies the user to input a user-generated public key. In one embodiment, the deposit account system transmits an electronic instruction to the browser to alter its interface to display an input for accepting a public key. The public key may be a previously generated public key of a public/private key pair that the user has previously been using to conduct transactions on the blockchain. The user may now wish to transfer bitcoin or other cryptocurrency into the deposit account from the user's previously-created public/private key pair or digital wallet. At step 224, the user inputs the previously-generated public key into the interface provided by the browser and the browser transmits the public key through the secure connection to the deposit account system, where it is stores in step 226.

Next, at step 228, the deposit account system requests user payment information. In one embodiment, a user may initially fund the deposit account using a credit card transaction. In this embodiment, the deposit account system transmits an electronic instruction to the browser interface to display an input for accepting credit card payment information at step 230, and the information is then transmitted to the deposit account system. At step 232, the deposit account system validates the completeness of the payment information, and then validates the correctness of the payment information at step 234. At step 236, the deposit account system transmits the payment information to a third party payment processing system to process the credit card payment. At step 238, the deposit account system awaits for payment confirmation from the third party system.

At step 240, once payment confirmation has been received, the deposit account system proceeds to verify that the public key input by the user is actually controlled by the user in order to verify that the user has control over the account represented by the public key. The deposit account system does this by initiating a trial payment from the public/private key pair generated in the deposit account creation step to the previously-determined public key provided by the user—and then awaiting the transmission of the trial payment back from the user's previously determined public key to the public key generated in the deposit account creation step. Thus, at step 240, the deposit account may determine an amount of cryptocurrency less than or equal to the previous credit card payment and then purchase or transfer the amount of cryptocurrency to the public key generated in the deposit account creation step. At step 242, the deposit account system may then post the transaction from the deposit account public key to the predetermined user public key to the blockchain. The deposit account system may then wait for confirmation of the transaction from the blockchain at step 244. In one example, the confirmation may be the creation of a predetermined number of blocks including a reference to the transaction.

Next, at step 246, the user receives the trial payment at the user's predetermined public key and then initiates a transaction of an identical amount of cryptocurrency back to the public key created in the deposit account creation step. This illustrates that the user has control over the public/private key pair associated with the predetermined public key, and that the user is also aware of the correct public key to transfer the trial payment to—and thus is the user that has established the deposit account. Next, at step 248, the deposit account system monitors the blockchain to determine whether there has been a transaction transferring cryptocurrency to the public key associated with the deposit account and then waits for confirmation from the blockchain. At step 250, the deposit account system verifies that the received payment to the public key associated with the deposit account matches the trial payment transmitted to the predetermined user public key. When the values match, the process proceeds to step 252 and the deposit account system transmits an electronic instruction to the browser interface to notify the user that their account has been established.

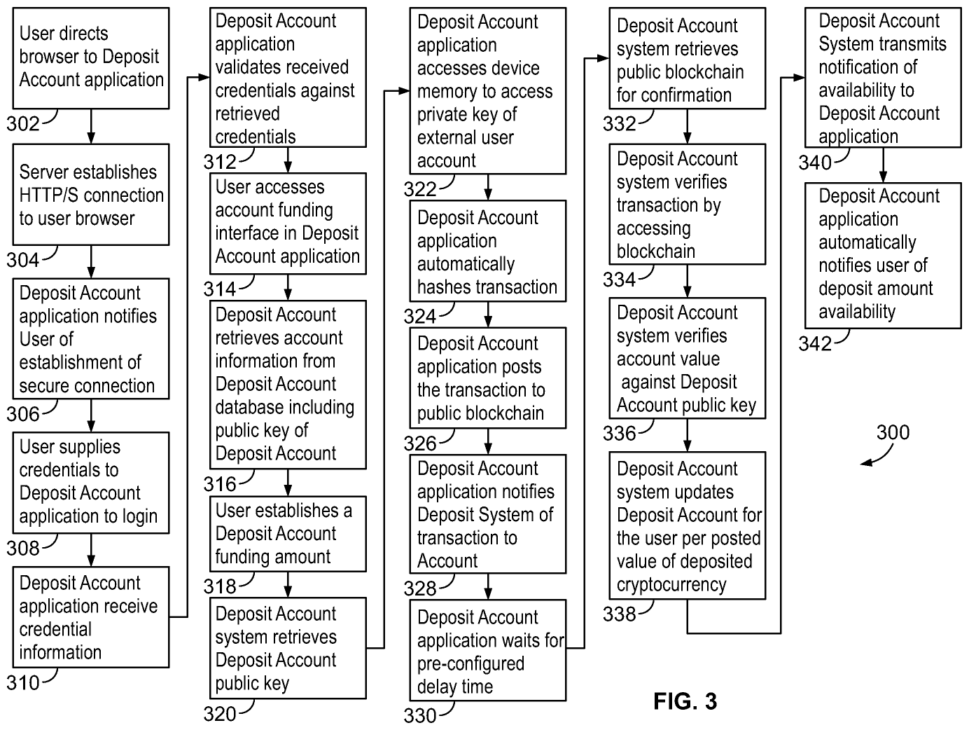

FIG. 3 illustrates a flowchart 300 of a method for funding a deposit account with cryptocurrency received from a predetermined public key or digital wallet. First, at step 302, the user directs a browser to the deposit account application. The deposit account application may be operative on a desktop or a mobile computing device. Next, at step 304, the server upon which the deposit account system is operating establishes a secure connection with the user's browser, such as a HTTP/S connection. Next, at step 306, the deposit account system notifies the user's browser of the establishment of a secure connection and an indication may be displayed for the user. Then, at step 308, the browser displays an interface to allow the user to enter security credentials such as a password. The security credentials are transmitted to the deposit account application at step 310 and then validated against retrieved user account security credentials at step 312. In one embodiment, the user account security credentials may be stored in the deposit account data store and retrieved by the deposit account system.

Next, at step 314, the user accesses an account funding interface in the deposit account application. In one example, the user may access such an interface by selecting a link in the account application. At step 316, the deposit account retrieves account information from the deposit account database including the public key associated with the account.

At step 318, the user enters a deposit account funding amount of cryptocurrency to be transferred from a previous account associated with a predetermined user public key to a public key associated with the deposit account. At step 320, the deposit account system may retrieve the public key associated with the deposit account.

At step 322, the application retrieves the private key associated with the predetermined, external user account. In one embodiment, the private key may already be stored in memory on the device on which the application is operating. In another embodiment, the application may allow the user to directly enter the private key, for example by using a QR code. Next, at step 324, the application initiates a transaction from the external account to the deposit account by using the external account private key and received deposit account funding amount, hashing the transaction, and then posting the transaction to the public blockchain at step 326.

Then, at step 328, the deposit account application sends a notification to the deposit account system of the transaction. In one embodiment, the deposit account application may transmit an account identifier, a transaction amount, the public key of the external account, and/or the public key of the deposit account to the deposit account application. The notification may be used to alert the deposit account application to monitor the blockchain for the transaction and, when a transaction from the external account to the public key associated with the deposit account is detected, to confirm that the amount of the transaction is as expected. At step 330, the deposit account application and the deposit account system wait for the pre-configured delay time, such as 3 or 7 iterations of block formation of the blockchain. Next, at step 332, the deposit account system retrieves data from the public block chain for confirmation. At step 334, the deposit account system verifies the transaction by determining whether the transaction that has been posted to the blockchain matches the expected transaction received from the notification from the deposit account application. At step 336, the deposit account system verifies that the account value associated with the deposit account public key on the blockchain is the expected account value taking into account the transaction from the notification.

Next, at step 338, the deposit account system updates the deposit account data in the deposit account system for the user to reflect the value of the deposited cryptocurrency that is now associated with the public key of the user's deposit account. At step 340, the deposit account system transmits a notification of availability of cryptocurrency to the deposit account application. Next, at step 342, the deposit account application automatically notifies the user of deposit amount availability. In one embodiment, the receipt of the notification of availability from the deposit account system causes the deposit account application to automatically display an interface including data regarding the available amount of cryptocurrency associated with the deposit account public key as well as data with regard to the received transaction.

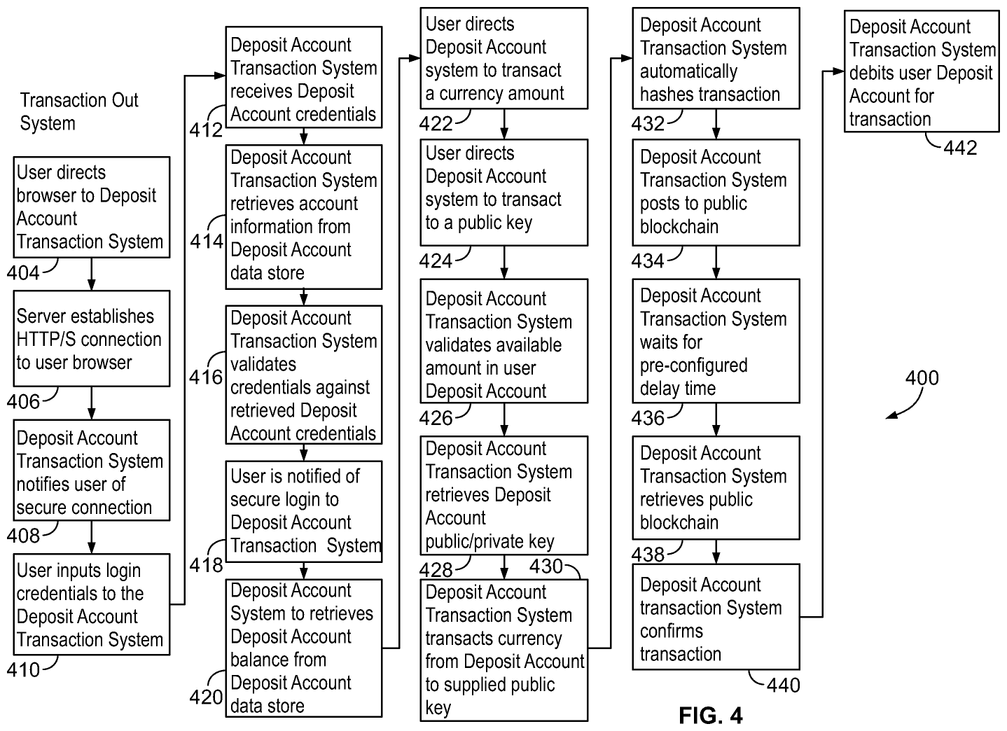

FIG. 4 illustrates a flowchart 400 of a method for processing an outgoing transaction from the deposit account system. First, at step 404, the user directs a browser to the deposit account transaction system, for example by selecting a link in an application displayed by the browser. Next, at step 406, the server upon which the deposit account system is operating establishes a secure connection with the user's browser, such as a HTTP/S connection. Next, at step 408, the deposit account system notifies the user's browser of the establishment of a secure connection and an indication may be displayed for the user. Then, at step 410, the browser displays an interface to allow the user to input the user's account security credentials, such as a password. At step 412, the deposit account credentials are received by the deposit account system and at step 414, the deposit account transaction system retrieves account information associated with the deposit account from the deposit account data store. At step 416, the deposit account transaction system validates the received security credentials against the account information received from the deposit account data store. Then, at step 418, the user is notified of a successful secure login to the deposit account transaction system. In one embodiment, when the received security credentials match the retrieved information from the deposit account data store, the deposit account system sends an electronic instruction to the browser to display an interface indicating a successful security validation.

Next, at step 420, the deposit account system retrieves a cryptocurrency balance associated with the deposit account from the deposit account data store. The cryptocurrency balance may also be transmitted as data to the browser for display in an interface to the user. Then, at step 422, the user may direct the deposit account system to transact an amount of cryptocurrency. In one example, the interface displayed in the browser may include a user-selectable option to initiate a cryptocurrency transaction and may allow a user to enter an amount of cryptocurrency to transact. Additionally, at step 424, the browser interface allows the user to select or identify a public key to which cryptocurrency should be transferred. In one embodiment, the public key to which cryptocurrency is to be transferred may be a predetermined public key that was used by the user in establishing the deposit account or that the user previously used to transfer cryptocurrency to the public key associated with the deposit account. In both of these situations, the public key of the external accounts are preferably stored in the deposit account data store and associated with the deposit account. The public keys are retrievable and are selectable by the user through the interface, for example through a drop-down menu.

Then, at step 426, the deposit account transaction system compares the desired cryptocurrency amount received for the transaction to the available cryptocurrency associated with the user's deposit account. In one example the comparison may merely be to the stored account value data retrieved from the deposit account data store. Alternately, the deposit account system may also access the blockchain using the public key associated with the deposit account to verify that the amount of cryptocurrency associated with the public key of the deposit account is equal to or greater than the desired cryptocurrency amount for the transaction and matches the account value stored in the deposit account data store. At step 428, the deposit account transaction system retrieves the deposit account public/private key pair, and then at step 430 uses the deposit account private key and the public key of the account to which the cryptocurrency should be transferred to perform the transfer of cryptocurrency from the deposit account to the desired third party public/private key pair or wallet. This includes automatically hashing the transaction at step 432 and then posting the transaction to the public blockchain at step 434.

At step 436, the deposit account transaction system then waits for a pre-configured delay time, such as the time required to form 3 or 7 blocks of the block chain. Then, at step 438, the deposit account transaction system accesses the public blockchain, and confirms that the transaction took place at step 440. In one embodiment, the deposit account transaction system may confirm the transaction by determining that the value associated with the public key to which the transfer has been made has increased by the desired amount and/or determining that the public key associated with the deposit account has decreased by the desired amount.

Finally, at step 442, the deposit account transaction system updates and stores the user deposit account information to reflect the transaction.

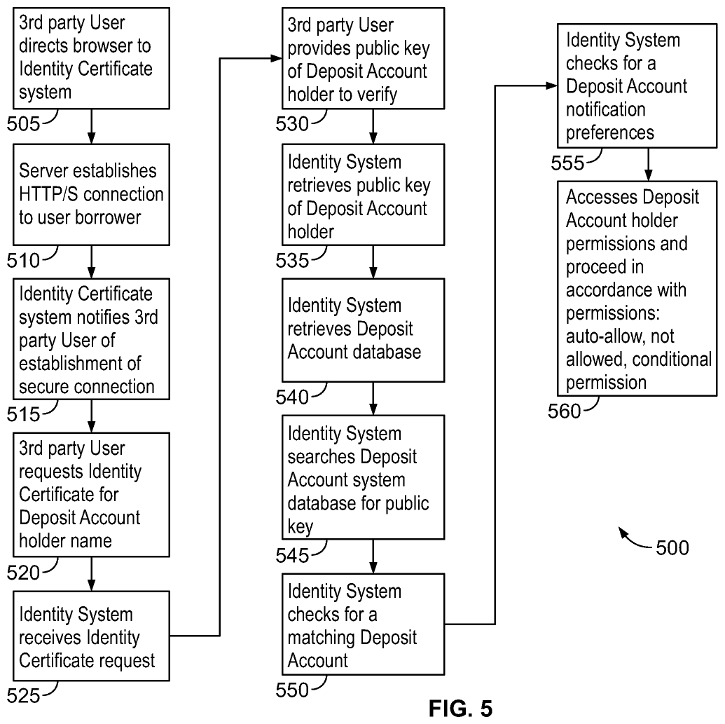

FIGS. 5-8 illustrate an identity verification system according to an embodiment of the present invention. In the system of FIGS. 5-8, a deposit account has already been created and verified as set forth above. For example, the deposit account system has already verified the identity of the user associated with the deposit account using bank-level security verification techniques. Additionally, the deposit account system has verified that the external public key is associated with the user by the process of creating a public private key pair associated with the deposit account, initiating a trial transaction from the deposit account to the external public key, and receiving a transaction back from the external public key in the amount of the trial transaction. This demonstrates that the person associated with control over the external public key also possesses the information of the deposit account public key. Further, because the deposit account is associated with a known identity of the user, the external public key may now also be associated with the same known user identity, and a certificate that the external public key is associated with a known user identity may be provided to third parties as shown in FIGS. 5-8.

FIG. 5 illustrates a flowchart 500 of a method for automated identity verification according to an embodiment of the present invention. First, at step 505, an identity certificate system is accessible by a third party using a browser. At step 510, the server upon which the identity certificate system is operating establishes a secure connection with the user's browser, such as a HTTP/S connection. Next, at step 515, the identity certificate system notifies the user's browser of the establishment of a secure connection and an indication may be displayed for the user.

At step 520, the third party user enters a name that may be associated with a deposit account into the user interface provided by the browser, and the name is transmitted to the identity certificate system at step 525. At step 530, the third party enters the public key that may be associated with the name into the user interface provided by the browser. For example, the public key may be entered manually, by password, or by QR code. The public key is then transmitted to the identity certificate system at step 535.

Next, at step 540, the identity certificate system accesses the deposit account database and at step 545 searches the deposit account database for a matching public key and name. If a match is found, at step 550, the identity certificate system retrieves the deposit account associated with the public key and name, and at step 555 retrieves the deposit account notification preferences associated with the deposit account. The deposit account preferences may be pre-configured by the deposit account owner.

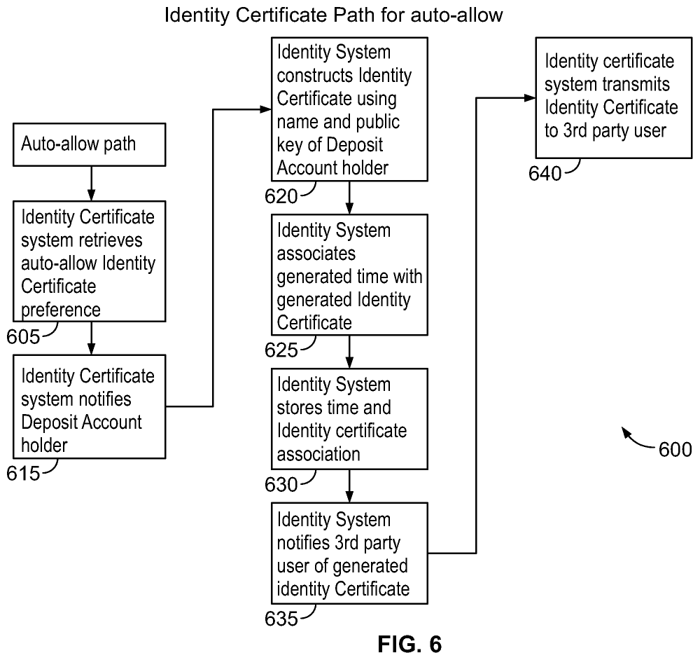

At step 560, the identity certificate system proceeds in accordance with the deposit account preferences as shown in FIGS. 6-8. The deposit account preferences include: auto-allow, not allowed, and conditional permission.

In an alternative embodiment, in addition to the public key that is transmitted to the identity certificate system at step 535, the system may require entry of a security code, such as bank PIN number that would have been previously provided to the deposit account owner, and then validate that PIN number is associated with the deposit account owner before proceeding.

In an alternative embodiment, the system may require the deposit account owner to interact with the system to cause the system to generate a time-limited security code, such as a security code that might expire in 15 minutes. In addition to the public key that is transmitted to the identity certificate system at step 535, the system may require entry of the time-limited security code, and may then validate the time-limited security code before proceeding.

FIG. 6 illustrates a flowchart 600 of a method for implementing the auto-allow preference. First, at step 605, the identity certificate system retrieves the deposit account preferences associated with the deposit account and determined the preference to be auto-allow. Next, at step 615, the identity certificate system sends an electronic notification to the deposit account holder. In one embodiment, when the identity certificate system retrieves the deposit account preferences, the identity certificate system also retrieves an e-mail address or phone number associated with the deposit account and then transmits an email or text alerting the deposit account holder of the issuance of an identity certificate.

Next, at step 620, the identity certificate system constructs an identity certificate using the name and public key of the deposit account holder. Additionally, at step 625, the current time is determined and added to the identity certificate. In one embodiment, the identity certificate is a digitally signed .pdf that uses a digital signature endorsed by the institution controlling the deposit account. The .pdf lists the name and associated public key, as well as the time of generation. The digital signature serves to prevent tampering.

Then, at step 630, the identity certificate system stores the time of creation and a copy of the identity certificate, an association with the deposit account owner and any identity information associated with the third party requester. At step 635, the identity certificate system notifies the third party user of a generated identity certificate, and then electronically transmits the certificate to the third party user at step 640.

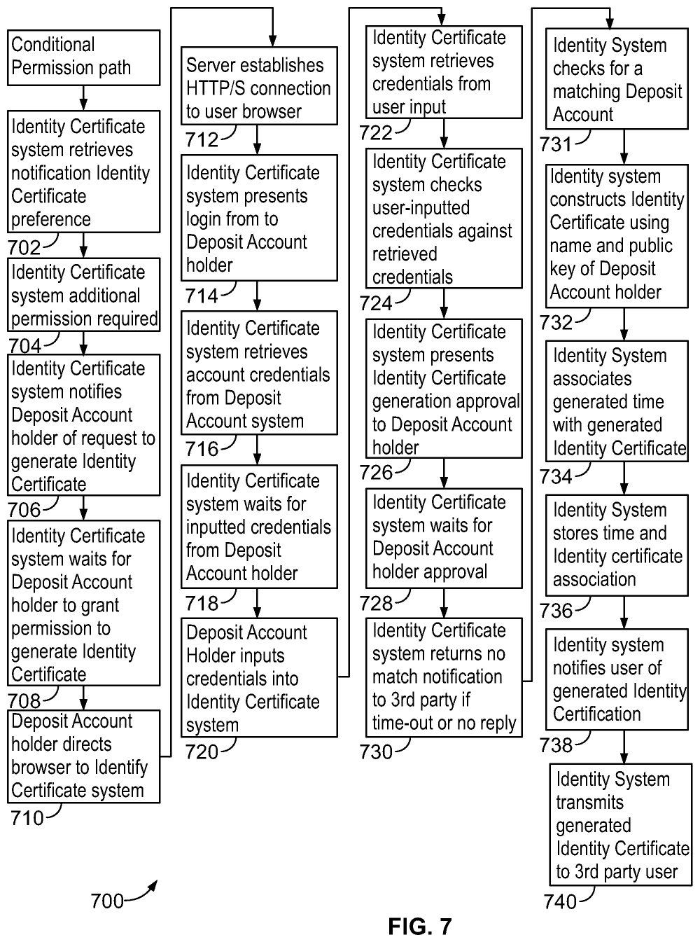

FIG. 7 illustrates a flowchart 700 of a method for implementing the conditional permission preference. First, at step 702, the identity certificate system retrieves the deposit account preferences associated with the deposit account and determines the preference to be conditional permission. Next, at step 704, the identity certificate system implements the additional permission required process. At step 706, the identity certificate system notifies the deposit account holder that a request has been received from a third party to generate an identity certificate, for example by e-mail or text. At step 708, the identity certificate system waits for the deposit account holder to grant permission to generate the identity certificate. If permission is not received within a predetermined time, the request fails and the third party user is provided with an electronic notification that the process has failed.

At step 710, once the deposit account holder has received notification that a request to generate an identity certificate has been received, the deposit account holder must authorize the process to continue. In order to authorize the process to continue, the deposit account holder directs a browser initiate communication with the identity certificate system. Next, at step 712, the server upon which the identity certificate system is operating establishes a secure connection with the user's browser, such as a HTTP/S connection. At step 714, the identity certificate system causes the browser to display an interface with login form for the deposit account holder. At step 716, the identity certificate system receives account credentials from the deposit account system. Then, at step 718, the identity certificate system waits to receive credentials from the user through the interface of the browser. At step 720, the deposit account holder inputs their credentials into the browser interface and the credentials are transmitted to the identity certificate system at step 722. At step 724, the identity certificate system checks the received credentials against the retrieved credentials. Then, at step 726, when the credential match, the identity certificate system causes the interface on the browser to display an identity certificate generation approval link, and the identity certificate system then waits for a response at step 728. At step 730, if the identity certificate generation approval link is not activated within a predetermined time, the identity certificate system returns a failure or no-match notification to the third party.

At step 731, once the activation of the identity certificate generation approval link has been received by the identity certificate system, the identity certificate system proceeds to use the name and public key information provided by the third party to search for a matching deposit account. At step 732, the identity certificate system constructs an identity certificate using the name and public key of the deposit account holder. Additionally, at step 7334, the current time is determined and added to the identity certificate. In one embodiment, the identity certificate is a digitally signed .pdf that uses a digital signature endorsed by the institution controlling the deposit account. The .pdf lists the name and associated public key, as well as the time of generation. The digital signature serves to prevent tampering.

Then, at step 736, the identity certificate system stores the time of creation and a copy of the identity certificate, an association with the deposit account owner and any identity information associated with the third party requester. At step 738, the identity certificate system notifies the third party user of a generated identity certificate, and then electronically transmits the certificate to the third party user at step 740.

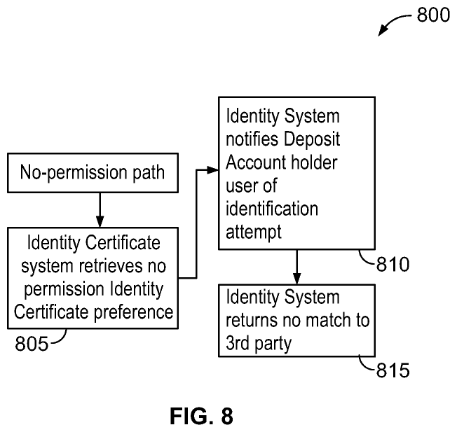

FIG. 8 illustrates a flowchart 800 of a method for implementing the not allowed preference. First, at step 805, the identity certificate system retrieves the deposit account preferences associated with the deposit account and determines the preference to be not allowed. Next, at step 810, the identity certificate system searches the deposit account information and if a deposit account is found with a matching name and public key, the identity certificate system notifies the account holder that there has been an attempt by a third party to verify their information. Finally, at step 815, the identity certificate system returns “no match” or “process failed” to the third party.

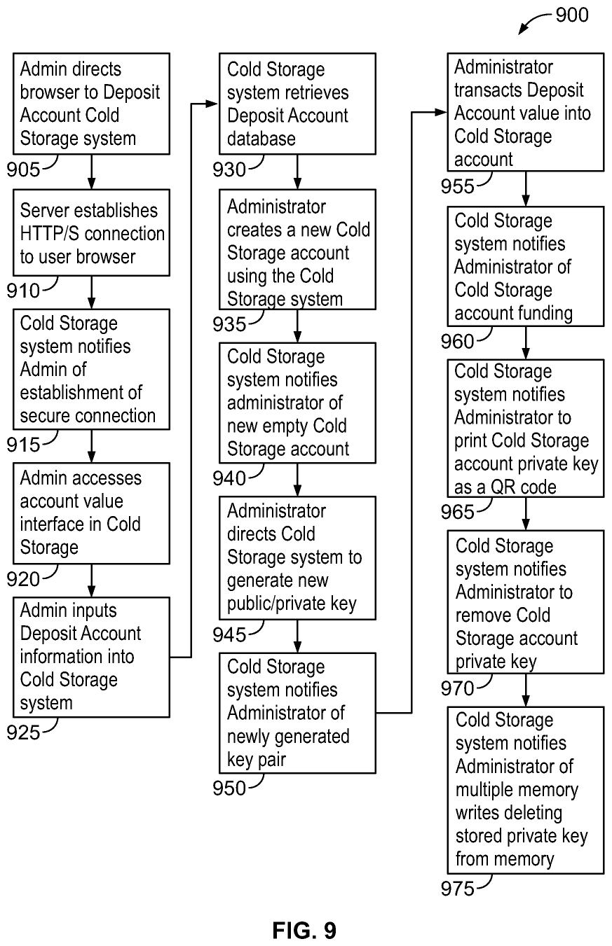

FIG. 9 illustrates a flowchart 900 of a method for deposit account cold storage. At step 905, an administrator directs a browser to a deposit account cold storage system. At step 910, the server upon which the deposit account cold storage system is operating establishes a secure connection with the administrator's browser, such as a HTTP/S connection. Next, at step 915, the deposit account cold storage system notifies the admin of the establishment of a secure connection. In one embodiment, the deposit account cold storage system transmits an instruction to the interface displayed by the browser to display an electronic indication of the establishment of a secure connection. Then, at step 920, the administrator uses the browser to access an account value interface of the deposit account cold storage system. At step 925, the administrator enters deposit account information into the deposit account cold storage system, and at step 930, the deposit account cold storage system accesses the deposit account database. At step 935, the administrator creates a new cold storage account associated with the deposit account using the deposit account cold storage system. Then, at step 940, the deposit account cold storage system notifies the administrator of a new empty cold storage account, for example, by causing the interface displayed by the browser to display an electronic indication. At step 945, the administrator directs the deposit account cold storage system to generate a new public/private key pair to be associated with the cold storage account. Then, at step 950, the deposit account cold storage system notifies the administrator of the new generated key paid.

At step 955, the administrator transacts some value of cryptocurrency that is currently associated with the deposit account public/private key paid into the cold storage public/private key pair. This transaction is posted to the blockchain. At step 960, the deposit account cold storage system notifies the administrator that the cold storage account has been funded. Additionally, the deposit account cold storage system may wait for 3 or 7 blocks to be created before proceeding and may verify that the expected amount of the transaction has been deducted from the deposit account key pair and credited to the cold storage key pair.

At step 965, the deposit account cold storage system notifies the administrator to print the cold storage account private key as a QR code—and then notifies the administrator to remove the cold storage account private key from memory at step 970. At step 975, the deposit account cold storage system proceeds to remove the cold storage private key from memory and conducts multiple memory overwrites to ensure that the private key is not recoverable. The deposit account cold storage system then notifies the administrator of the deletion of the private key, for example, by providing an electronic instruction to the interface displayed on the browser to show an electronic indication in that regard.

Although the above process steps have been accomplished by an administrator, they may also be accomplished in an automated fashion. For example, the deposit account cold storage system may automatically move all or a part of the cryptocurrency received by the deposit account into cold storage. Then, when the deposit account wishes to transfer cryptocurrency to some other outside account, the deposit account may be temporarily funded by a transfer of cryptocurrency from an institution-level public/private key pair sufficient to perform the transaction. The institution-level account may then be reimbursed from the cold storage associated with the deposit account.

Alternatively, the transfer of cryptocurrency from the deposit account to the cold storage account may be at the discretion of the account owner. In this embodiment, the cold storage account may be automatically created at the time the deposit account is created, or may be created later at the electronic request of the account owner. The account owner may then be provided with an interface that allows the account owner to determine the amount of cryptocurrency to transfer to the key pair representing cold storage, and once the transfer is complete, the cold storage private key may be printed out and deleted from memory.

Alternatively, the deposit account may have multiple cold storage accounts associated with it. For example, whenever the deposit account wishes to place any cryptocurrency in cold storage, a new key pair may be generated for that transaction alone. Multiple transactions into cold storage each result in the creation of their own new key pair. All of the cold storage key pairs are associated with the deposit account and may be retrieved at the electronic instruction of the account holder.

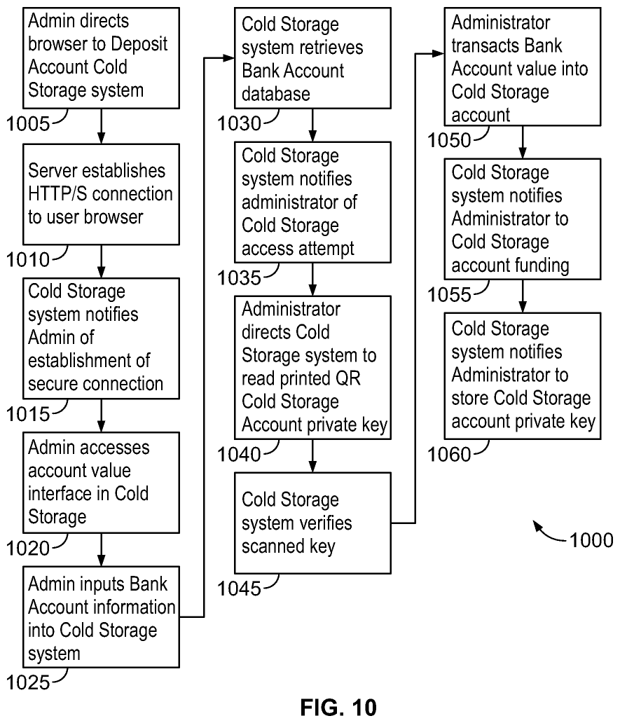

FIG. 10 illustrates a flowchart 1000 of a method for cold storage at the institution or bank level rather than the deposit account level. For bank-level cold storage, once cryptocurrency has been transmitted to the deposit account, all or a large part of the cryptocurrency may then be automatically transmitted to a bank-level key pair. At the bank-level key pair, cryptocurrency from many deposit accounts is agglomerated and a large fraction of the cryptocurrency may then be transmitted from the bank-level key pair to a bank-level cold storage key pair. In one embodiment, approximately 98% of cryptocurrency received may be placed in cold storage.

First, at step 1005, an administrator directs a browser to a bank-level cold storage system. At step 1010, the server upon which the bank-level cold storage system is operating establishes a secure connection with the administrator's browser, such as a HTTP/S connection. Next, at step 1015, the bank-level cold storage system notifies the admin of the establishment of a secure connection. In one embodiment, the bank-level cold storage system transmits an instruction to the interface displayed by the browser to display an electronic indication of the establishment of a secure connection. Then, at step 1020, the administrator uses the browser to access an account value interface of the bank-level cold storage system. At step 1025, the administrator enters bank account information into the bank-level cold storage system, and at step 1030, the bank-level cold storage system accesses the bank account database and/or cold storage data store.

At step 1035, the bank-level cold storage system notifies the administrator of a cold storage access attempt. In response, at step 1040, the administrator directs the bank-level cold storage system to read a printed QR code representing the bank-level cold storage private key. At step 1045, the bank-level cold storage system verifies the scanned key.

Then, at step 1050, the administrator transfers cryptocurrency from the bank account key pair into the cold storage account key pair. This transaction is then posted to the blockchain. At step 1055, the bank-level cold storage system notifies the administrator of the cold storage account funding, for example, but sending an electronic communication to the interface displayed by the browser.

The bank-level cold storage system then notifies the administrator to restore the cold storage account private key. Consequently, the private key is printed out, deleted from memory, and the memory overwritten.

Alternatively, similar to the alternates mentioned above, the process may take place automatically once a predetermined amount of cryptocurrency has been agglomerated into the bank-level key pair.

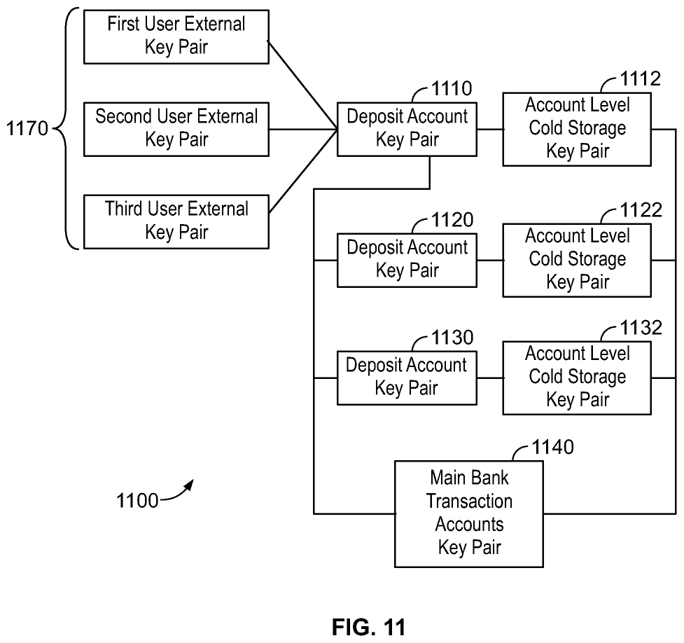

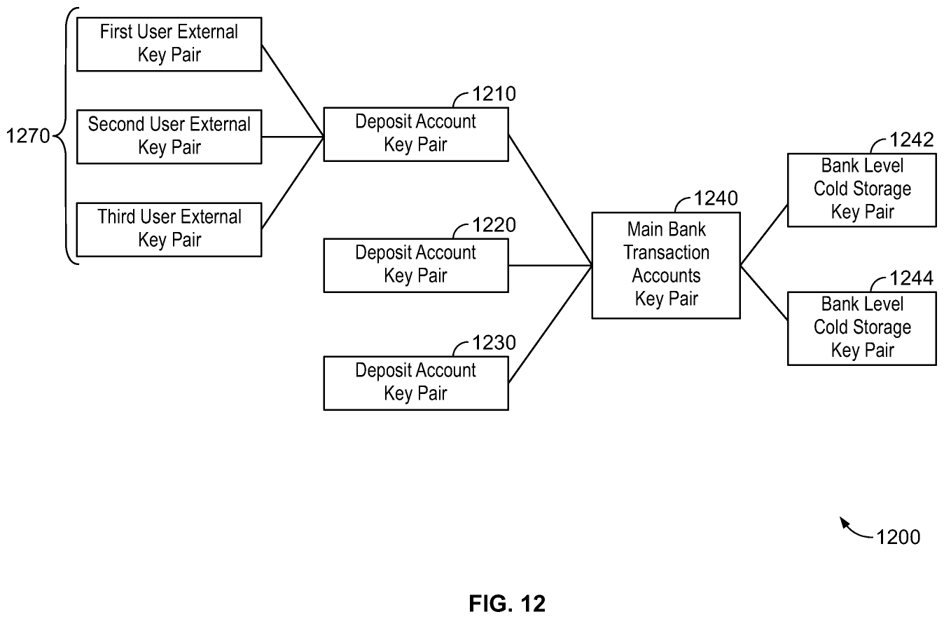

FIGS. 11 and 12 further illustrate the processes described in FIGS. 9 and 10. In FIG. 11, a deposit account key pair 1110 was created at the time the deposit account was created, as was an account-level cold storage key pairs 1112 that is associated with the deposit account key pair 1110. Additional deposit account key pairs 1120, 1130 have their own associated account-level cold storage key pairs 1122, 1132. Both the deposit account key pairs 1110, 1120, 1130, and the cold storage key pairs 1112, 1122, 1132 may transact with the main bank transaction accounts key pair 1140. Additionally, it is noted that several external key pairs 1170, may be associated with any one deposit account key pair 1110.

In FIG. 12, as discussed in FIG. 10, the deposit account key pairs 1210, 1220, 1230, transact with the main bank transaction accounts key pair 1240. Cryptocurrency may then be placed into one or more bank-level cold storage key pairs 1242, 1244 from the main bank transaction accounts key pair 1240. Again, it is noted that several external key pairs 1270, may be associated with any one deposit account key pair 1210.

Some alternative embodiments to the present system include additional functionality as described below. The blockchain is anonymous. Transactions are trackable based on public keys, but the fact that a specific public key is owned by a specific person is not directly verifiable. Consequently, ownership of bitcoin by a specific person is also not directly verifiable. Conversely, we want a system so that a financial institution can verify that a specific person owns a specific amount of bitcoin that is on deposit with a financial institution. Consequently, we will allow a bitcoin owner to transfer bitcoin from their account (public/private key pair) to the account of a financial institution (institution's public/private key pair). The transaction is posted to the blockchain so that the financial institution is now the owner of the bitcoin. Conceptually, this passes ownership and control of those bitcoins from the original owner to the financial institution.

When the transfer is made, the financial institution verifies the identity of the person making the transfer and creates an internal account linking that person's identity with an accounting entry at the bank indicating a balance of bitcoin on deposit with the financial institution. As part of the process, the person making the “deposit” would enter their public key, so the financial institution would be able to verify that a specific amount of bitcoin was received from that public key. The public key would also be stored. This allows the financial institution to satisfy all the “know your customer” and/or tax reporting requirements because the account entry is associated with a specific person. This accounting entry is not posted to the blockchain because the bitcoin is meant to remain the property of and under the control of the financial institution.

At a later time, if desired, the original person may instruct the financial institution to “withdraw” their bitcoin, at which point the financial institution will review the account balance and transfer that amount of bitcoin to the public key associated with the account. That transaction will be posted to the blockchain because ownership and control of the bitcoin is passing back to the original user public key. Any “know your customer” and/or tax reporting requirements would also be accomplished. Additionally, at any point prior to “withdrawal”, the original depositor can cause the financial institution to issue a digitally signed depository receipt (DSDR) which is the financial institution's statement as to the amount of bitcoin that is currently credited to the account of the original depositor as of the timestamp of the digitally signed depository receipt. The depository receipt is signed with the digital signature of the financial institution so that a third party in receipt of the DSDR can verify that the DSDR comes from the financial institution. The DSDR would include the name of the person on the account and the amount of bitcoin in the account—as of the timestamp that the DSDR was generated. The digital signature provides authentication, integrity, and non-repudiation of the account owner and account amount—at least as of the specific timestamp.

Thus, a third party receiving a DSDR can be assured that (as of the timestamp) the financial institution has the amount shown on deposit in account titled to the original depositor. Additionally, the original depositor can cause the financial institution to issue a new DSDR at any time that would show the current balance and can be sent to a third party—and verified by the third party. The acceptance of the incoming bitcoin and the establishment of the account may also include fraud-prevention steps. For example, if a bad actor has both the public and private keys of an innocent third party, they could set up an account at the financial institution in the name of the bad actor and then transfer the innocent third party's bitcoin to that account. Now the financial institution is in the position of issuing a DSDR based on theft. In order to avoid this, the financial institution would implement security or identity verification, for example uploaded photo ID, a webcam taking a picture of your face, a SSN, and a verified US bank account (if transferring funds in).

While particular elements, embodiments, and applications of the present invention have been shown and described, it is understood that the invention is not limited thereto because modifications may be made by those skilled in the art, particularly in light of the foregoing teaching. It is therefore contemplated by the appended claims to cover such modifications and incorporate those features which come within the spirit and scope of the invention.

1. A system for blockchain-based identity verification and transaction processing.
